(19) United States
(12) Patent Application Publication
(10) Pub. No.: US 2024/0008018 A1
(43) Pub. Date: Jan. 4, 2024

(54) Method, Apparatus and Computer Program for Machine Learning-Assisted Beams Coordinated Scheduling in 5G and Beyond

(71) Applicant: Nokia Solutions and Networks Oy, Espoo (FI)

(72) Inventors: Veronique Capdevielle, Magny les Hameaux (FR); Wolfgang AICHMANN, IIIertissen (DE); Santiago AGUDELO RAMIREZ, Paris (FR); Afef FEKI, Sceaux (FR); Fuad ABINADER, Massy (FR); Luis Guilherme UZEDA GARCIA, Massy (FR); Fahad SYED MUHAMMAD, Orsay (FR); Ahmed Farhan HANIF, Versailles (FR)

(21) Appl. No.: 18/039,761

(22) PCT Filed: Dec. 3, 2021
(86) PCT No.: PCT/EP2021/084087

§ 371 Date: Jun. 1, 2023

(30) Foreign Application Priority Data
Dec. 3, 2020 (FI) 20206243

(51) Int. Cl. H04W 72/044; H04W 72/541

(52) U.S. Cl. CPC H04W 72/046; H04W 72/541; H04W 84/18

(57) ABSTRACT

A method is provided for receiving, at a data collection entity, from each cell, a time series of a respective set of data where each set of data includes at least: one or more per-cell performance measurement data, one or more per-cell serving beams of each scheduled UE device, and a time and frequency allocation of each scheduled UE device to be served by the corresponding one or more per-cell serving beams; generating, by a cSON entity, from the sets of data received from the data collection entity, a set of cross-beam inter-cell interference profiles; establishing, by the cSON entity, from at least the set of cross-beam inter-cell interference profiles, a beam scheduling policy; receiving, at each cell, from the cSON entity, the beam scheduling policy; and applying, by a respective scheduler at each cell, the beam scheduling policy to each of the one or more per-cell serving beams.

### FIELD OF THE INVENTION

Various example embodiments relate to mobile or wireless telecommunication systems, and in particular to beams coordinated scheduling.

### BACKGROUND

Examples of mobile or wireless telecommunication systems may include the universal mobile telecommunications system (UMTS) terrestrial radio access network (UTRAN), long term evolution (LTE) evolved UTRAN (E-UTRAN), LTE-advanced (LTE-A), LTE-A Pro, and/or fifth generation (5G) radio access technology (RAT) or new radio (NR) access technology. 5G or NR wireless systems refer to the next generation (NG) of radio systems and network architecture. It is estimated that NR will provide bitrates on the order of 10-20 Gbit/s or higher and will support at least enhanced mobile broadband (eMBB) and ultra-reliable low-latency-communication (URLLC). NR is expected to deliver extreme broadband and ultra-robust, low latency connectivity and massive networking to support the Internet of things (IoT). With IoT and machine-to-machine (M2M) communication becoming more widespread, there will be a growing need for networks that meet the needs of lower power, high data rates, and long battery life. It is noted that a node that can provide in 5G or NR radio access functionality to a user equipment (UE) (i.e., similar to Node B in E-UTRAN or eNB in LTE) or that can support 5G or NR as well as connectivity to next generation core (also denoted by NGC or 5GC) may be referred to as a next generation or 5G Node B (also denoted by gNB or 5G NB).

### SUMMARY

According to an aspect, there may be provided a method comprising: receiving, at a data collection entity, from each cell, a time series of a respective set of data where each set of data comprises at least: one or more per-cell performance measurement data, one or more per-cell serving beams of each scheduled user equipment, UE, device, and a time and frequency allocation of each scheduled UE device to be served by the corresponding one or more per-cell serving beams; generating, by a centralized self-organizing network, cSON, entity, from the sets of data received from the data collection entity, a set of cross-beam inter-cell interference profiles; establishing, by the cSON entity, from at least the set of cross-beam inter-cell interference profiles, a beam scheduling policy; receiving, at each cell, from the cSON entity, the beam scheduling policy; and applying, by a respective scheduler at each cell, the beam scheduling policy to each of the one or more per-cell serving beams.

The set of cross-beam inter-cell interference profiles may comprise at least a respective interference probability for each serving beam pair of co-scheduled beams and a respective compliancy level for each set of co-scheduled beams, the co-scheduled beams comprising at least two serving beams which are each from a respective cell and which are scheduled on the same time and frequency resources.

The step of generating a set of cross-beam inter-cell interference profiles may comprise at least: labelling each set of co-scheduled beams as normal or abnormal depending on the one or more per-cell performance measurement data; training a machine learning model using each labelled set of co-scheduled beams and the one or more per-cell performance measurement data, as to obtain a trained machine learning model; using the trained machine learning model on the one or more per-cell performance measurement data per realization of co-scheduled beams to classify each set of co-scheduled beams as normal or abnormal depending on their respective compliancy level; and computing the respective interference probability for each serving beam pair of co-scheduled beams.

The compliancy level may be correlated to a cross-beam inter-cell interference level and to the one or more per-cell performance measurement data, each set of co-scheduled beams being classified as abnormal when the respective compliancy level is correlated to a high cross-beam inter-cell interference level and as normal when the respective compliancy level is correlated to a low cross-beam inter-cell interference level.

The step of labelling each set of co-scheduled beams as normal or abnormal depending on the one or more per-cell performance measurement data may be based at least:
on a first anomaly detection by: detecting an outlier based on the one or more per-cell performance measurement data; determining whether or not the detected outlier is associated with a performance degradation; labelling the set of co-scheduled beams corresponding to the detected outlier as abnormal when the detected outlier is associated with the performance degradation; labelling the set of co-scheduled beams corresponding to the detected outlier as normal when the detected outlier is not associated with the performance degradation; and labelling each other set of co-scheduled beams corresponding to no detected outlier as normal,
and/or
on a second anomaly detection by: forming a data cluster from the one or more per-cell performance measurement data; determining whether or not the data cluster is associated with a performance degradation; labelling each set of co-scheduled beams corresponding to the data of the data cluster as abnormal when the data cluster is associated with the performance degradation; and labelling each set of co-scheduled beams corresponding to the data of the data cluster as normal when the data cluster is not associated with the performance degradation.

The step of establishing a beam scheduling policy may comprise: building a pattern of beam penalties which are to be applied per cell to each of the one or more per-cell serving beams in order to selectively limit a use of one or more co-scheduled beams from respective cells on identical time and frequency resources.

The pattern may comprise one of a space time pattern, a space frequency pattern, and a space time and frequency pattern.

The step of building a pattern of beam penalties may comprise, when an interference probability is determined high for a serving beam pair of co-scheduled beams including a first serving beam from a cell and a second serving beam from another cell:
assigning a high level of beam penalty to the first serving beam and a low level of beam penalty to the second serving beam at a given slot, so as to limit a use of the first serving beam with respect to the second serving beam during the given slot; and assigning a low level of beam penalty to the first serving beam and a high level of beam penalty to the second serving beam at another slot subsequent to the given slot, so as to limit a use of the second serving beam with respect to the first serving beam during said another slot, wherein the slot may comprise at least one of a time slot and a frequency slot,
or
assigning a low level of beam penalty to the first serving beam and a high level of beam penalty to the second serving beam at a given slot, so as to limit a use of the second serving beam with respect to the first serving beam during the given slot; and assigning a high level of beam penalty to the first serving beam and a low level of beam penalty to the second serving beam at another slot subsequent to the given slot, so as to limit a use of the first serving beam with respect to the second serving beam during said another slot, wherein the slot may comprise at least one of a time slot and a frequency slot.

The interference probability may be determined high when the interference probability value is above a predetermined threshold value, and determined low when the interference probability value is below the predetermined threshold value.

The step of applying the beam scheduling policy to each of the one or more per-cell serving beams may comprise: determining, by the respective scheduler at each cell, which UE device and corresponding serving beam to schedule based on at least the pattern of beam penalties.

According to an aspect, there may be provided a system comprising means at least for: receiving, at a data collection entity, from each cell, a time series of a respective set of data where each set of data comprises at least: one or more per-cell performance measurement data, one or more per-cell serving beams of each scheduled user equipment, UE, device, and a time and frequency allocation of each scheduled UE device to be served by the corresponding one or more per-cell serving beams; generating, by a centralized self-organizing network, cSON, entity, from the sets of data received from the data collection entity, a set of cross-beam inter-cell interference profiles; establishing, by the cSON entity, from at least the set of cross-beam inter-cell interference profiles, a beam scheduling policy; receiving, at each cell, from the cSON entity, the beam scheduling policy; and applying, by a respective scheduler at each cell, the beam scheduling policy to each of the one or more per-cell serving beams.

According to an aspect, there may be provided a system comprising means at least for performing the above method.

The means comprised by the system may comprise: at least one processor; and at least one memory comprising computer program code, wherein the at least one memory and the computer program code are configured, with the at least one processor, to cause the performance of the system.

According to an aspect, there may be provided a method comprising: receiving, from a data collection entity, a time series of a respective set of data from each cell, where each set of data comprises at least: one or more per-cell performance measurement data, one or more per-cell serving beams of each scheduled user equipment, UE, device, and a time and frequency allocation of each scheduled UE device to be served by the corresponding one or more per-cell serving beams; generating, from the sets of data, a set of cross-beam inter-cell interference profiles; establishing, from at least the set of cross-beam inter-cell interference profiles, a beam scheduling policy; and transmitting, to a respective scheduler in each cell, the beam scheduling policy for application to each of the one or more per-cell serving beams.

According to an aspect, there may be provided a centralized self-organizing network, cSON, entity comprising means at least for: receiving, from a data collection entity, a time series of a respective set of data from each cell, where each set of data comprises at least: one or more per-cell performance measurement data, one or more per-cell serving beams of each scheduled user equipment, UE, device, and a time and frequency allocation of each scheduled UE device to be served by the corresponding one or more per-cell serving beams; generating, from the sets of data, a set of cross-beam inter-cell interference profiles; establishing, from at least the set of cross-beam inter-cell interference profiles, a beam scheduling policy; and transmitting, to a respective scheduler in each cell, the beam scheduling policy for application to each of the one or more per-cell serving beams.

The means comprised by the cSON entity may comprise: at least one processor; and at least one memory comprising computer program code, wherein the at least one memory and the computer program code are configured, with the at least one processor, to cause the performance of the cSON entity.

According to an aspect, there may be provided a computer readable medium comprising program instructions stored thereon for performing at least the following:
receiving, from each cell, a time series of a respective set of data where each set of data comprises at least: one or more per-cell performance measurement data, one or more per-cell serving beams of each scheduled user equipment, UE, device, and a time and frequency allocation of each scheduled UE device to be served by the corresponding one or more per-cell serving beams; generating, from the sets of data, a set of cross-beam inter-cell interference profiles; establishing, from at least the set of cross-beam inter-cell interference profiles, a beam scheduling policy; receiving the beam scheduling policy; and applying, at each cell, the beam scheduling policy to each of the one or more per-cell serving beams,
or
receiving, from each cell, a time series of a respective set of data where each set of data comprises at least: one or more per-cell performance measurement data, one or more per-cell serving beams of each scheduled user equipment, UE, device, and a time and frequency allocation of each scheduled UE device to be served by the corresponding one or more per-cell serving beams; generating, from the sets of data, a set of cross-beam inter-cell interference profiles; establishing, from at least the set of cross-beam inter-cell interference profiles, a beam scheduling policy; and transmitting, to each cell, the beam scheduling policy for application to each of the one or more per-cell serving beams.

The computer readable medium may be a non-transitory computer readable medium.

In the above, many different aspects have been described. It should be appreciated that further aspects may be provided by the combination of any two or more of the aspects described above.

Various other aspects are also described in the following detailed description and in the attached claims.

### BRIEF DESCRIPTION OF THE DRAWINGS

Some example embodiments will now be described with reference to the following accompanying drawings:

FIG. 1 shows an example schematic embodiment of a beam collision.

FIG. 2 shows an example schematic embodiment of a beam collision avoidance.

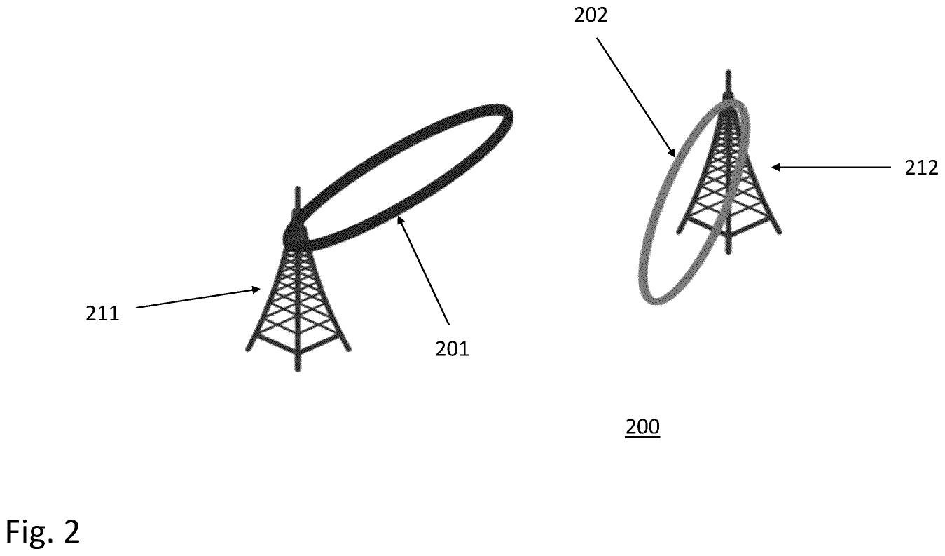

FIG. 3 shows an example schematic embodiment of a beams coordinated scheduling method comprising three subsequent phases with respective time scales.

FIG. 4A shows an example schematic embodiment of the first phase of the beams coordinated scheduling method when running in non-real time.

FIG. 4B shows an example schematic embodiment of the second phase of the beams coordinated scheduling method when running in near-real time.

FIG. 4C shows an example schematic embodiment of the third phase of the beams coordinated scheduling method when running in real time.

FIG. 5 shows an example flowchart describing an example embodiment of the beams coordinated scheduling method within an ORAN framework.

FIG. 6 shows an example schematic embodiment describing how the beams coordinated scheduling method when running in non-real time may generate a set of cross-beam inter-cell interference profiles.

FIG. 7 shows an example embodiment of a per-cell KPI for a set of co-scheduled beams from a respective cell plotted against time for illustrating the case of an example first anomaly detection.

FIG. 8 shows an example embodiment of data clustering based on SINR and RSRP along with interference quartiles plotted against the corresponding clusters for illustrating the case of an example second anomaly detection.

FIG. 9 shows an example schematic embodiment of a space time pattern of beam penalties.

FIG. 10 shows an example flowchart describing the beams coordinated scheduling method of FIG. 3 implemented at a system level.

FIG. 11 shows an example flowchart describing the beams coordinated scheduling method of FIG. 3 implemented at an apparatus level.

FIG. 12 shows an example embodiment of an apparatus.

FIG. 13 shows an example embodiment of computer readable media.

### DETAILED DESCRIPTION

The following example embodiments may apply to massive multiple-input multiple-output (MIMO) systems with beamforming. In particular, the MIMO systems may be single-user MIMO (SU-MIMO) systems or multi-user MIMO (MU-MIMO) systems.

Massive MIMO system is one of the key enablers for 5G wireless networks to optimize spectral efficiency. MIMO system relies on multiple antennas to transmit or receive data over multiple paths in the same radio channel. With beamforming, directional transmissions are achieved by combining, in amplitude and phase, the signals of antenna elements of the antenna array. Massive MIMO system implies an antenna grid with a large number of antenna elements capable of producing multiple focused beams to serve individual UE devices (e.g., a mobile device, a stationary device, an IoT device, or any other device capable of communication with a wireless communication network) simultaneously.

In an example, beamforming may be based on grid of beams (GoB), which is made of an overlay of beams wherein each beam points towards a defined direction in space for coverage. In an alternative scenario, beamforming may be based on more sophisticated beamforming algorithms such as eigen-based beamforming (EBB). For effective isotropic radiated power (EIRP) control, each applied eigen beam may be expanded in terms of discrete Fourier transform (DFT) beams (the dominant ones at least) to then use these DFT beams instead of the best GoB beams.

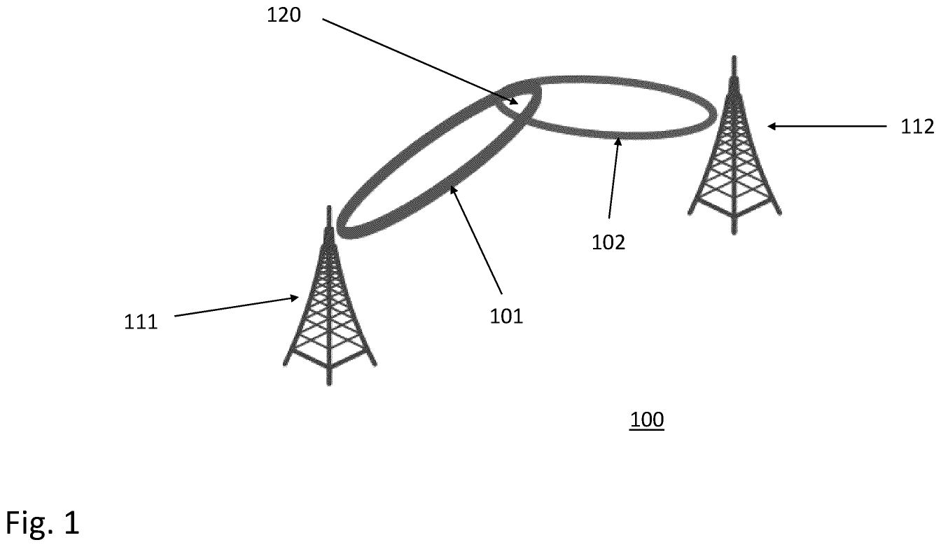

In an example embodiment, each scheduled UE device may be served in downlink (DL) by a beam from the GoB that is operated by its serving cell. As illustrated in FIG. 1, the DL transmission to the scheduled UE device may be interfered by beams of co-scheduled UE devices (i.e., UE devices which are scheduled at a same time slot) from neighboring cells using the same carrier frequency. As depicted in FIG. 1 showing an example schematic embodiment 100 of a beam collision, if at least two beams 101, 102 from different serving cells 111, 112 are conflicting, i.e., partially or fully covering the same overlapped area 120, the corresponding mutual interference may cause a significant performance drop.

To illustrate the negative impact of such mutual interference, simulations have been conducted using a system-level simulator. An Urban Macro cellular scenario consisting of three-sectorized sites with an inter-site distance of 200 meters has been simulated, and the simulated traffic was full buffer. The simulation scenario has taken place at FR1 frequency band. As known in the prior art, two different frequency ranges FR1 and FR2 are available for the 5G technology. FR1 stands for frequency range 1 and includes frequency bands from 410 to 7125 MHz, and FR2 stands for frequency range 2 and includes frequency bands from 24.25 GHz to 52.6 GHz. The simulation scenario has been directed to a SU-MIMO scenario with antennas at the base stations (BS) consisting of a 2×4×4 panel configuration and with a GOB with 8 beams. For each beam numbered from 0 to 7, the following Table I gives the corresponding azimuth and elevation angles used in the simulation scenario.

TABLE 1
Azimuth and elevation angles (in degrees)
used in the simulation scenario

| Beam | 0 | 1 | 2 | 3 | 4 | 5 | 6 | 7 |
|---|---|---|---|---|---|---|---|---|
| Azimuth | 40 | 60 | 80 | 100 | 120 | 140 | 65 | 115 |
| Elevation | −20 | −20 | −20 | −20 | −20 | −20 | −35 | −35 |

After performing simulations in “interference” and “non-interference” scenarios, the analysis of different key performance indicators (KPIs), such as the signal-to-interference-plus-noise ratio (SINR) (also known as the signal-to-noise-plus-interference ratio (SNIR)) and the modulation and coding scheme (MCS), has shown a quite significant drop on the network's performance when interference from neighboring cells was present. In more details, the results have shown that the mean value of SINR had decreased from 27 dB in absence of interference to 16 dB in presence of interference. For MCS, the simulations have been configured in such a manner that an MCS value of 15 and above was corresponding to a normal performance of the network, and that an MCS value below 15 was corresponding to a degraded performance. There has been approximately 4 MCS dropping below 15 per second in the non-interference scenario, against 28 MCS dropping below 15 per second in the interference scenario.

Thus, these simulation results have revealed how critical it is to manage these cross-beam inter-cell interference scenarios in order to fulfill 5G performance requirements.

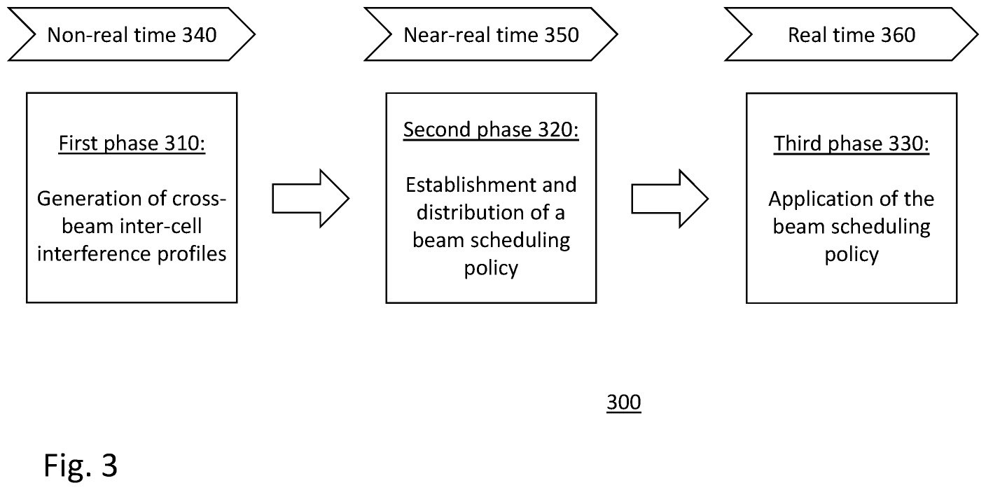

FIG. 3 shows an example schematic embodiment 300 of a beams coordinated scheduling method in three subsequent phases, i.e., a first phase denoted by 310, a second phase denoted by 320, a third phase denoted by 330, with respective time scales denoted by non-real time 340, near-real time 350 and real time 360.

The first phase 310 may refer to generation of cross-beam inter-cell interference profiles. The second phase 320 may refer to establishment and distribution of a beam scheduling policy, and the third phase 330 may refer to application of the beam scheduling policy.

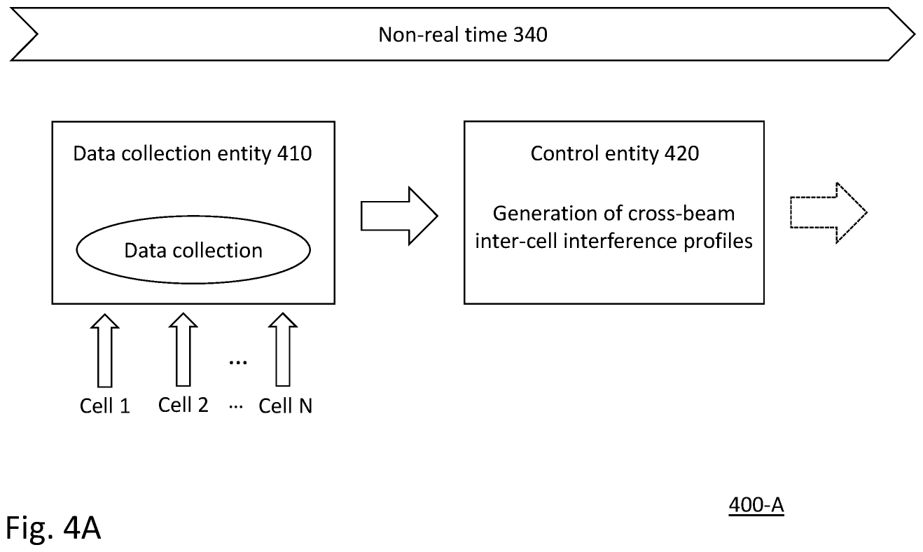

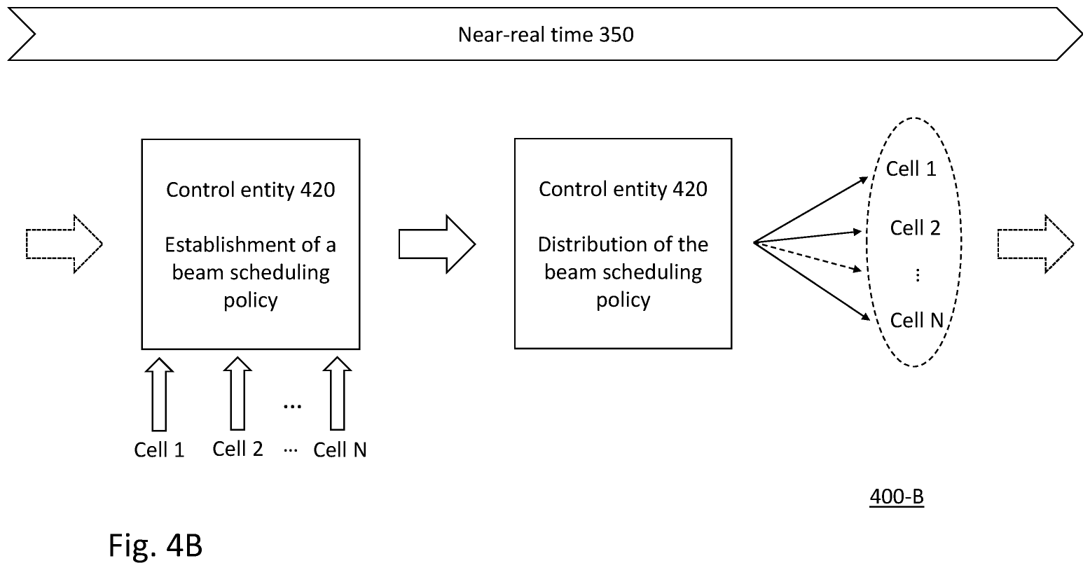

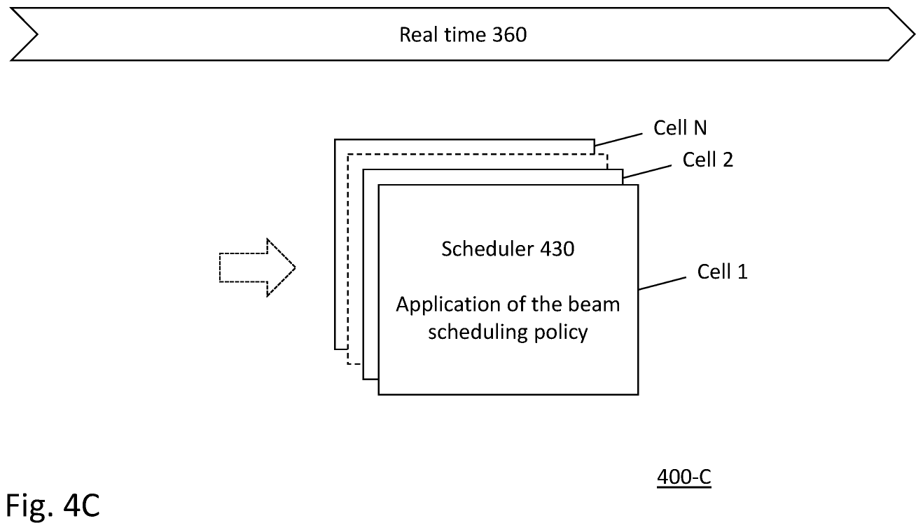

In connection with FIG. 3, FIG. 4A shows an example schematic embodiment 400-A of the first phase 310 of the beams coordinated scheduling method when running in non-real time 340.

As shown, each cell (denoted by cell 1, cell 2, . . . , cell N) may transmit a time series of a respective set of data to a data collection entity 410, e.g., a 3GPP entity or any other propriety solution. These data may be collected by each cell from the data or measurements reported over time by each scheduled UE device. In an example embodiment (as shown), the data collection entity 410 may be a centralized entity that is shared by the whole cells (i.e., cell 1 to cell N). In another example embodiment (not shown), the data collection entity 410 may be a distributed entity that is split into a plurality of data collection entities respectively dedicated to each cell. Each set of data may comprise at least one or more per-cell performance measurement data, one or more per-cell serving beams of each scheduled UE device, and a time and frequency allocation of each scheduled UE device to be served by the corresponding one or more per-cell serving beams. In an example, the performance measurement data collected by each cell from each scheduled UE device may comprise KPIs such as, but not limited to, SINR or SNIR, MCS, reference signal received power (RSRP), channel quality indicator (CQI), reference signal received quality (RSRQ), number or rate of packet retransmissions through acknowledgement (ACK) and/or non-acknowledgement (NACK) reports, and open loop link adaptation (OLLA) offsets.

Useful data of the collected sets of data may be transmitted to a control entity 420. In an example embodiment, the control entity 420 may be a centralized self-organizing network (cSON) entity (or platform), and the cSON entity 420 may, for example, comprise a RAN intelligent controller (RIC) or any other propriety solution. It should be appreciated that a centralized solution based on the use of the centralized data collection entity 410 and the cSON entity 420 may avoid complex and fast coordination of the cells that would be required in the case of a distributed solution for optimally controlling scheduling decisions. The useful data may comprise the one or more per-cell performance measurement data, the one or more per-cell serving beams of each scheduled UE device, and the time and frequency allocation of each scheduled UE device to be served by the corresponding one or more per-cell serving beams. The control entity 420 may then generate a set of cross-beam inter-cell interference profiles from the received useful data. The set of cross-beam inter-cell interference profiles may comprise at least a respective interference probability for each serving beam pair of co-scheduled beams and a respective compliancy level for each set of co-scheduled beams, the co-scheduled beams comprising at least two serving beams which are each from a respective cell and which are scheduled on the same time and frequency resources.

In connection with FIG. 3, FIG. 4B shows an example schematic embodiment 400-B of the second phase 320 of the beams coordinated scheduling method when running in near-real time 350.

As shown, the control entity 420 may establish (or set up) a beam scheduling policy from at least the generated set of cross-beam inter-cell interference profiles and then distribute the beam scheduling policy to each cell (denoted by cell 1, cell 2, . . . , cell N). In addition to the generated set of cross-beam inter-cell interference profiles, other data reported by each cell (denoted by cell 1, cell 2, . . . , cell N) to the control entity 420 may be used to establish the beam scheduling policy. These other data may relate to, for example, traffic load, beam priorities to define based on UE priorities, and so on.

In connection with FIG. 3, FIG. 4C shows an example schematic embodiment 400-C of the third phase 330 of the beams coordinated scheduling method when running in real time 360.

As shown, the distributed beam scheduling policy may be applied in real time to each of the one or more per-cell serving beams, by a respective scheduler 430 (e.g., a gNB scheduler) at each cell (denoted by cell 1, cell 2, . . . , cell N).

At the gNB level, a loop on an evaluation of update requirements may be performed to update, if needed, the beam scheduling policy, by triggering again the beams coordinated scheduling method starting from the first phase 310.

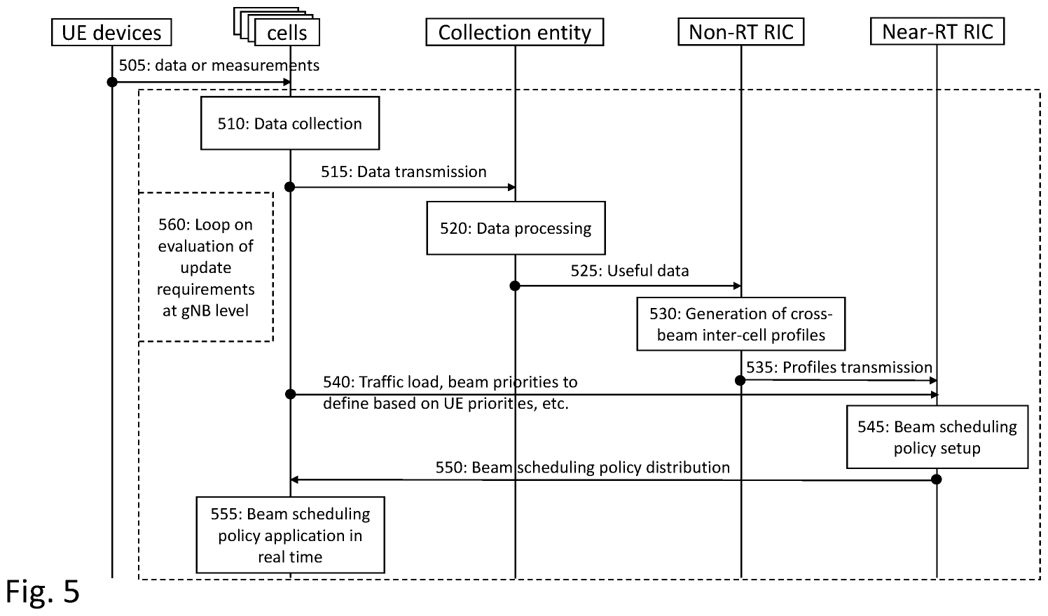

In connection with FIGS. 3 and 4, FIG. 5 shows an example flowchart 500 describing an example embodiment of the beams coordinated scheduling method within an open-RAN (ORAN) framework. The flowchart 500 depicts a call flow and the message exchanges between different entities within the ORAN framework involving UE devices, serving cells, a collection entity as the data collection entity 410, and a RIC as the control entity 420 or the cSON entity 420. Therein, the RIC is designated as a non-real time RIC (denoted by non-RT RIC) when operating in the second phase 320 and as a near-real time RIC (denoted by near-RT RIC) when operating in the third phase 330. The example flowchart 500 may comprise the following steps 505 to 560.

Step 505: each scheduled UE device may report over time data or measurements to each of its serving cells.

Step 510: each of its serving cells may collect over time a respective set of data from the reported data or measurements.

Step 515: each serving cell may transmit a time series of the collected respective set of data to the collection entity through, for example, a troubleshooting interface. Each set of data may comprise at least one or more per-cell performance measurement data (e.g., KPIs), one or more per-cell serving beams of each scheduled UE device, and a time and frequency allocation of each scheduled UE device to be served by the corresponding one or more per-cell serving beams.

Step 520: The collection entity may process each of the received set of data to extract useful data. The useful data may comprise the one or more per-cell performance measurement data, the one or more per-cell serving beams of each scheduled UE device, and the time and frequency allocation of each scheduled UE device to be served by the corresponding one or more per-cell serving beams.

Step 525: The collection entity may transmit the useful data to the non-RT RIC.

Step 530: The non-RT RIC may generate a set of cross-beam inter-cell interference profiles from the received useful data. The set of cross-beam inter-cell interference profiles may comprise at least a respective interference probability for each serving beam pair of co-scheduled beams and a respective compliancy level for each set of co-scheduled beams, the co-scheduled beams comprising at least two serving beams which are each from a respective serving cell and which are scheduled on the same time and frequency resources.

Step 535: The non-RT RIC may transmit to the near-RT RIC, the generated set of cross-beam inter-cell interference profiles.

Step 540: Each serving cell may transmit to the near-RT RIC, data relating to, for example, traffic load, beam priorities to define based on UE priorities, and so on.

Step 545: The near-RT RIC may establish (or set up) a beam scheduling policy from the generated set of cross-beam inter-cell interference profiles and, optionally, from the data received from each serving cell.

Step 550: The near-RT RIC may distribute the beam scheduling policy to each serving cell.

Step 555: Each scheduler 430 (e.g., gNB scheduler) at each serving cell may apply in real time the beam scheduling policy to each of the one or more per-cell serving beams.

Step 560: At the gNB level, a loop on an evaluation of update requirements may be performed to update, if needed, the beam scheduling policy, by triggering again the beams coordinated scheduling method.

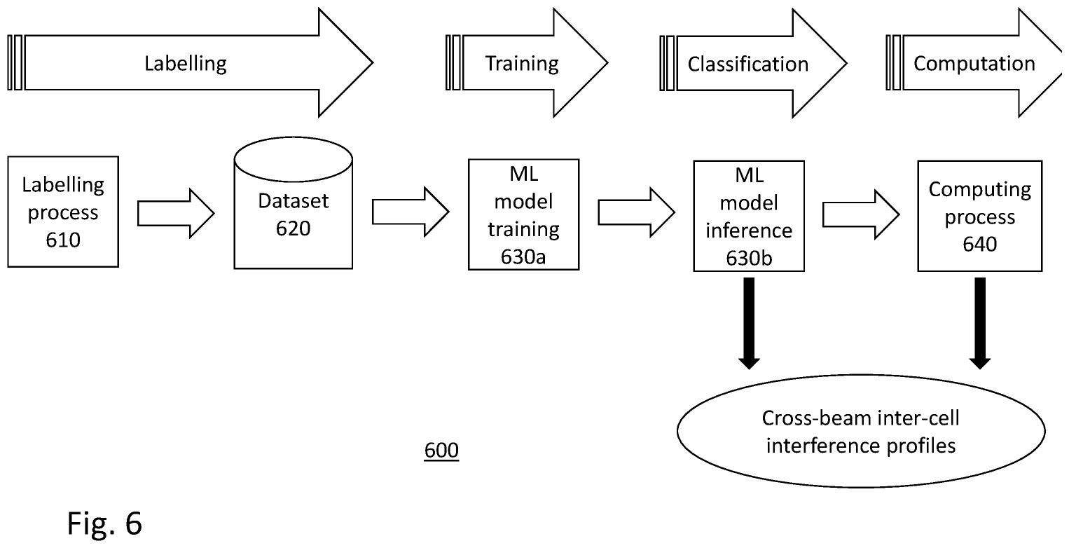

In connection with FIGS. 3, 4A and 5 when referring to the step 530 of the first phase 310, FIG. 6 shows an example schematic embodiment 600 describing how the beams coordinated scheduling method when running in non-real time 340 may generate a set of cross-beam inter-cell interference profiles.

As shown, the generation of the set of cross-beam inter-cell interference profiles may comprise the following steps: labelling 610 each set of co-scheduled beams as normal or abnormal depending on the one or more per-cell performance measurement data (e.g., KPIs); training a machine learning (ML) model 630a using a dataset 620 comprising each labelled set of co-scheduled beams and the one or more per-cell performance measurement data as to obtain a trained ML model 630b once the training of the ML learning model 630a has terminated; using the (inference of the) trained ML model 630b on the one or more per-cell performance measurement data per new realization of co-scheduled beams to classify each set of co-scheduled beams as normal or abnormal depending on their respective compliancy level; and computing 640 the respective interference probability for each serving beam pair of co-scheduled beams.

The ML model 630a, 630b may be a supervised ML model that may comprise a neural network (NN) or an artificial neural network (ANN) model, itself comprising, for example, but not limited to, a deep neural network (DNN) (also known as feedforward neural network (FNN) or multilayer perceptron) model, a recurrent neural network (RNN) model, or a convolutional neural network (CNN) model.

The compliancy level may be correlated to a cross-beam inter-cell interference level and to the one or more per-cell performance measurement data, wherein each set of co-scheduled beams is classified as abnormal when the respective compliancy level is correlated to a high cross-beam inter-cell interference level and as normal when the respective compliancy level is correlated to a low cross-beam inter-cell interference level.

Referring to FIG. 6, the step of labelling each set of co-scheduled beams as normal or abnormal depending on the one or more per-cell performance measurement data may be based on an anomaly detection. In a non-limiting example, the anomaly detection may comprise a first anomaly detection based on detection (or identification) of outlier(s) from observed per-cell performance measurement data (e.g., KPIs). In another non-limiting example, the anomaly detection may comprise a second anomaly detection based on data clustering. The data clustering may comprise, for example, but not limited to, K-means clustering, density-based spatial clustering of applications with noise (DBSCAN), Gaussian mixture model clustering, spectral clustering and agglomerative clustering.

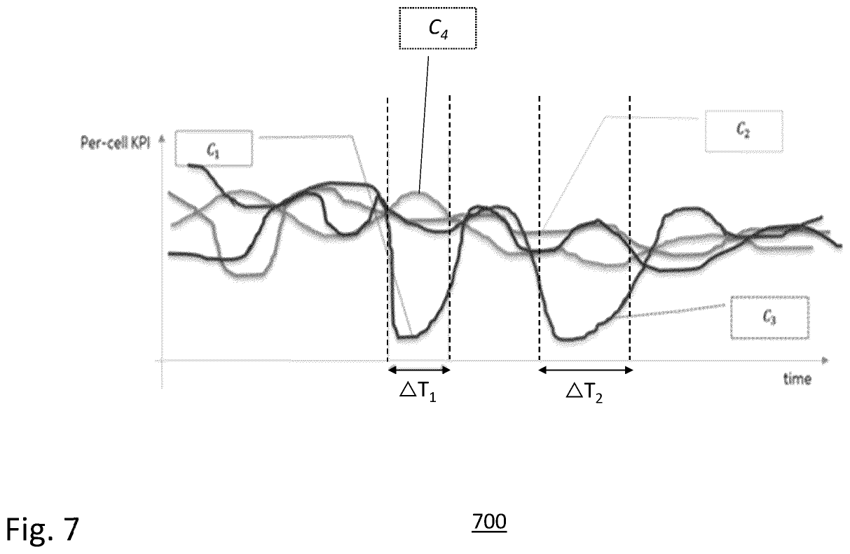

FIG. 7 shows an example embodiment 700 of a per-cell KPI for a set of co-scheduled beams from a respective cell C₁, C₂, C₃ or C₄ plotted against time for illustrating the case of an example first anomaly detection.

As depicted, the beam scheduled in the cell C₁ corresponds during the time slot denoted by ΔT₁ to a detected (or identified) KPI drop, which detected KPI drop may then be considered an outlier, with respect to the respective KPI corresponding to the other beams co-scheduled in the cells C₂, C₃ and C₄. This thereby means that the beam scheduled during this time slot ΔT₁ in the cell C₁ is impacted by the beams transmitted by the other (neighboring) cells C₂ to C₄ during the same time slot ΔT₁. As further depicted, the beam scheduled in the cell C₃ corresponds during a time slot denoted by ΔT₂ to a detected (or identified) KPI drop, which detected KPI drop may then be considered an outlier, with respect to the respective KPI corresponding to the other beams co-scheduled in the cells C₁, C₂ and C₄. This thereby means that the beam scheduled during this time slot ΔT₂ in the cell C₃ is impacted by the beams transmitted by the other (neighboring) cells C₁, C₂ and C₄ during the same time slot ΔT₂. Although each of the example time slots ΔT₁ and ΔT₂ encompasses a plurality of times, it shall be understood that in the example case where a time slot ΔT has a minimum width, the time slot ΔT can then designate a single time t.

More generally, once an outlier has been detected (or identified) at a first time slot based on the one or more per-cell performance measurement data, it may be determined whether or not the detected outlier is associated with a performance degradation. The set of co-scheduled beams (i.e., the set of beams scheduled at the same first time slot) corresponding to the outlier having been detected at the first time slot may be labelled as abnormal for the first time slot when the detected outlier is associated with the performance degradation, as it is the case, for example, for the outliers of FIG. 7 which have been detected at ΔT₁ and ΔT₂. The set of co-scheduled beams corresponding to the outlier having been detected at the first time slot may be labelled as normal for the first time slot when the detected outlier is not associated with the performance degradation. And each other set of co-scheduled beams corresponding to no outlier having been detected at a second time slot may be labelled as normal for the second time slot.

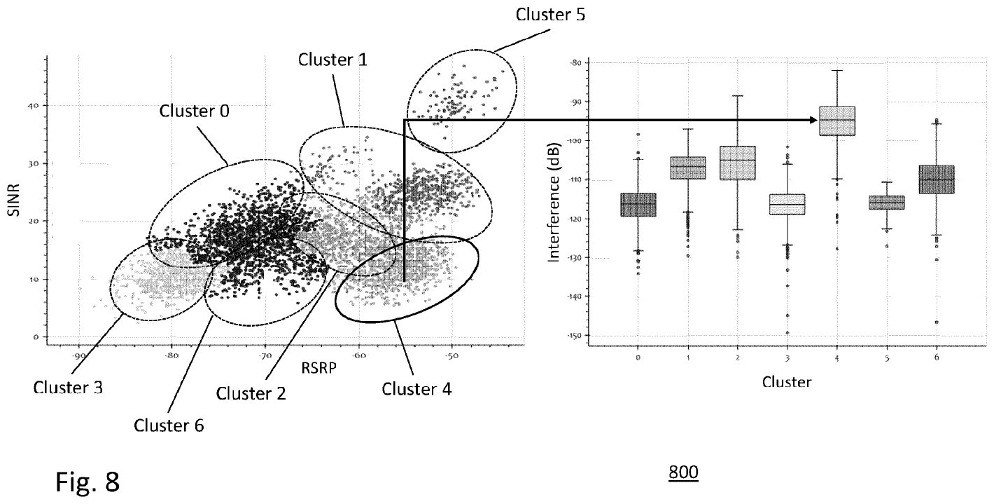

FIG. 8 shows an example embodiment 800 of data clustering based on SINR and RSRP along with interference quartiles plotted against the corresponding clusters for illustrating the case of an example second anomaly detection.

As depicted, the RSRP and SINR as KPIs were used to form seven clusters (numbered from 0 to 6) of simulated data. The cluster 4 has been detected (or identified) as presenting an anomaly with respect to the other clusters 0, 1, 2, 3, 5, 6 because it presents low SINR and high RSRP simultaneously, which may then stand for interference situations. Thus, the detected (or identified) cluster 4 may be labelled as abnormal. From the plotted interference quartiles per cluster, it can be inferred that the cluster 4 corresponds to the highest noticed median interference value, thereby indicating that the interference is indeed the source of the abnormal behavior of this cluster 4.

More generally, once a data cluster has been formed from the one or more per-cell performance measurement data, it may be determined whether or not the data cluster is associated with a performance degradation. Each set of co-scheduled beams (i.e., each set of beams scheduled at a same time slot) corresponding to the data of the data cluster may be labelled as abnormal for the time slot when the data cluster is associated with the performance degradation, as it is the case, for example, for the cluster 4 of FIG. 8. Each set of co-scheduled beams corresponding to the data of the data cluster may be labelled as normal for the time slot when the data cluster is not associated with the performance degradation, as it may be the case, for example, for the clusters 0, 1, 2, 3, 5, 6 of FIG. 8.

Referring to FIG. 6, the step of computing the respective interference probability P for each serving beam pair of co-scheduled beams (Bᵢ, Bⱼ) may comprise computing the following relationship (1):

$$P ( interference \vert {B}_{i} and {B}_{j} are scheduled ) = \frac{P ( interference ⋂ {B}_{i} and {B}_{j} are scheduled )}{P ( {B}_{i} and {B}_{j} are scheduled )} \qquad ( 1 )$$

where i∈cell m and j∈cell n with m≠n.

The interference probability P may be determined low when its value is below a predetermined threshold value, and determined high when its value is above the predetermined threshold value.

In connection with FIGS. 3, 4B and 5 when referring to the step 545 of the second phase 320, the step of establishing a beam scheduling policy may comprise building a pattern of beam penalties which are to be applied per cell to each of the one or more per-cell serving beams in order to selectively limit a use of one or more co-scheduled beams from respective cells on identical time and frequency resources.

The pattern may comprise one of a space time pattern, a space frequency pattern, and a space time and frequency pattern.

The building of the pattern of beam penalties may rest on the principle of switching from the cross-beam inter-cell interference profiles to the pattern of beam penalties.

In an example embodiment, let p_{i,m} the penalty to apply on the beam i (Bᵢ) in the cell m, and let p_{j,n} the penalty to apply on the beam j (Bⱼ) in the cell n.

It is then admitted that the absolute value of the difference between p_{i,m} and p_{j,n} is a an increasing monotonically function of the interference probability P for each serving beam pair of co-scheduled beams (Bᵢ, Bⱼ). Mathematically speaking, it corresponds to the following relationship (2):

|p_{i,m}−p_{j,n}|=f(P(interference|Bᵢ and Bⱼ are scheduled)) (2)

where f is an increasing monotonically function.

Thus, if P(interference|Bᵢ and Bⱼ are scheduled) is high, then a low penalty p_{i,m} on Bᵢ implies a high penalty p_{j,n} on Bⱼ, then a high penalty p_{i,m} on Bᵢ implies a low penalty p_{j,n} on Bⱼ.

Thereby, the use of these co-scheduled beams Bᵢ and Bⱼ on the same time and frequency resources may be selectively limited.

Based on it, the pattern of beam penalties may be built by swapping the high and low penalties per group of the most interfering cells, so that no beam may be favored compared to others on the long term thanks to the pattern application.

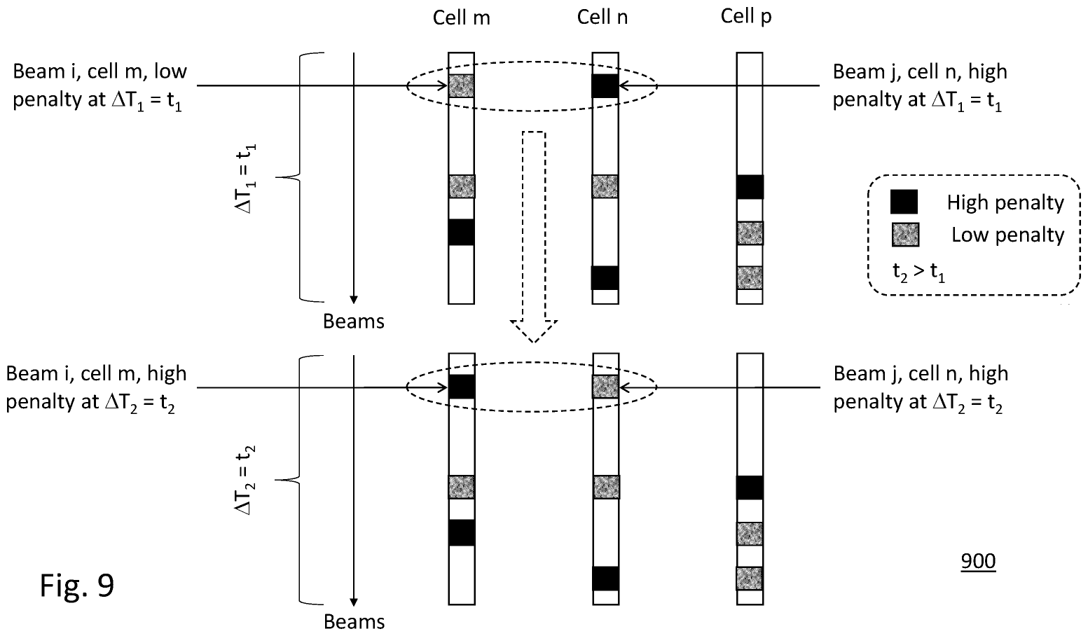

FIG. 9 shows an example schematic embodiment 900 of a space time pattern of beam penalties.

As exemplarily depicted, a low penalty is applied on the beam i (Bᵢ) in the cell m and a high penalty is applied on the beam j (Bⱼ) in the cell n at a time slot ΔT₁=t₁. Then, at a subsequent time slot ΔT₂=t₂ (where t₂>t₁), the penalties are swapped such that a high penalty is applied on the beam i (Bᵢ) in the cell m and a low penalty is applied on the beam j (Bⱼ) in the cell n.

More generally, when an interference probability is determined high for a serving beam pair of co-scheduled beams including a first serving beam from a cell and a second serving beam from another cell, the step of building a pattern of beam penalties may either comprise:
assigning a high level of beam penalty to the first serving beam and a low level of beam penalty to the second serving beam at a given slot, so as to limit a use of the first serving beam with respect to the second serving beam during the given slot; and assigning a low level of beam penalty to the first serving beam and a high level of beam penalty to the second serving beam at another slot subsequent to the given slot, so as to limit a use of the second serving beam with respect to the first serving beam during said another slot, wherein the slot may comprise at least one of a time slot and a frequency slot,
or comprise:
assigning a low level of beam penalty to the first serving beam and a high level of beam penalty to the second serving beam at a given slot, so as to limit a use of the second serving beam with respect to the first serving beam during the given slot; and assigning a high level of beam penalty to the first serving beam and a low level of beam penalty to the second serving beam at another slot subsequent to the given slot, so as to limit a use of the first serving beam with respect to the second serving beam during said another slot, wherein the slot comprises at least one of a time slot and a frequency slot.

In connection with FIGS. 3, 4C and 5 when referring to the step 555 of the third phase 330, the step of applying the beam scheduling policy to each of the one or more per-cell serving beams may comprise determining, by the respective scheduler (e.g., gNB scheduler) at each cell, which UE device and corresponding serving beam to schedule based on at least the pattern of beam penalties. Indeed, the beams serving each UE device are set according to a conventional beam management procedure and, at each cell, the respective scheduler then decides which UE device and related serving beam to schedule based on this beam scheduling policy to apply. Thus, the use of each beam per cell may be limited according to the built pattern of beam penalties.

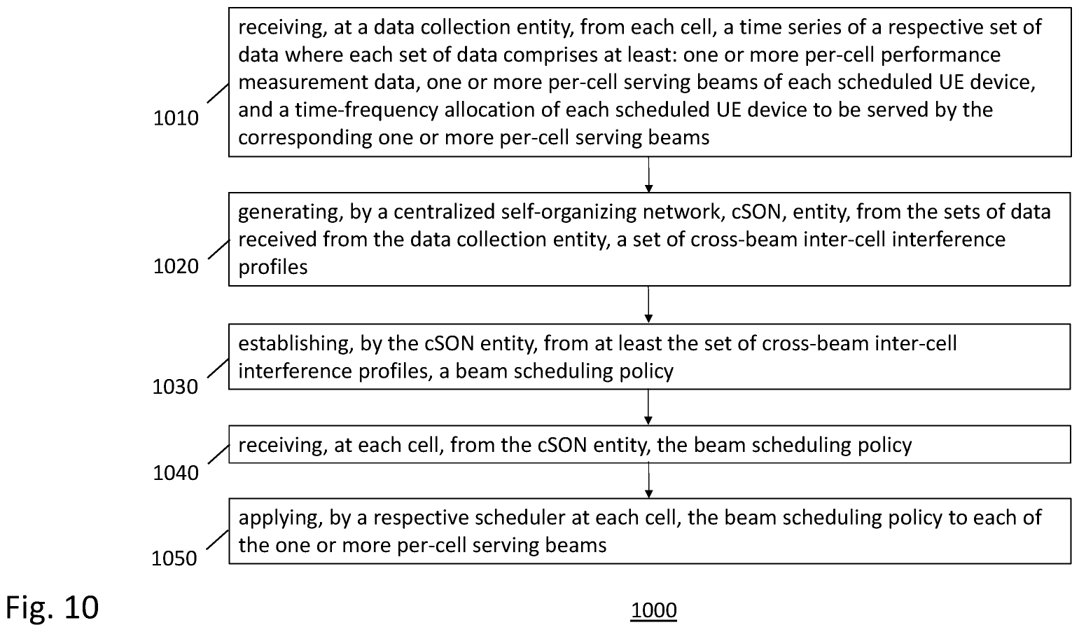

FIG. 10 shows an example flowchart 1000 describing the beams coordinated scheduling method of FIG. 3 implemented at a system level.

In step 1010, the method may comprise means for receiving, at a data collection entity 410, from each cell, a time series of a respective set of data where each set of data comprises at least: one or more per-cell performance measurement data, one or more per-cell serving beams of each scheduled UE device, and a time and frequency allocation of each scheduled UE device to be served by the corresponding one or more per-cell serving beams.

In step 1020, the method may comprise means for generating, by a cSON entity 420, from the sets of data received from the data collection entity 410, a set of cross-beam inter-cell interference profiles.

In step 1030, the method may comprise means for establishing, by the cSON entity 420, from at least the set of cross-beam inter-cell interference profiles, a beam scheduling policy.

In step 1040, the method may comprise means for receiving, at each cell, from the cSON entity 420, the beam scheduling policy.

In step 1050, the method may comprise applying, by a respective scheduler 430 at each cell, the beam scheduling policy to each of the one or more per-cell serving beams.

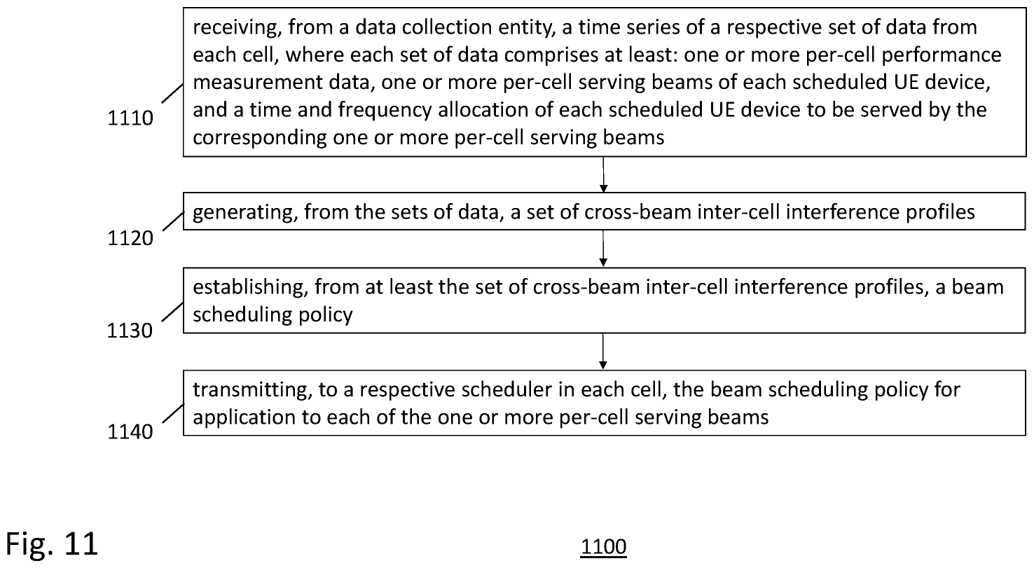

FIG. 11 shows an example flowchart 1100 describing the beams coordinated scheduling method of FIG. 3 implemented at a device level. The device may be the control entity 420 or the cSON entity 420.

In step 1110, the method may comprise means for receiving, from a data collection entity 410, a time series of a respective set of data from each cell, where each set of data comprises at least: one or more per-cell performance measurement data, one or more per-cell serving beams of each scheduled UE device, and a time and frequency allocation of each scheduled UE device to be served by the corresponding one or more per-cell serving beams.

In step 1120, the method may comprise means for generating, from the sets of data, a set of cross-beam inter-cell interference profiles.

In step 1130, the method may comprise means for establishing, from at least the set of cross-beam inter-cell interference profiles, a beam scheduling policy.

In step 1140, the method may comprise means for transmitting, to a respective scheduler 430 in each cell, the beam scheduling policy for application to each of the one or more per-cell serving beams.

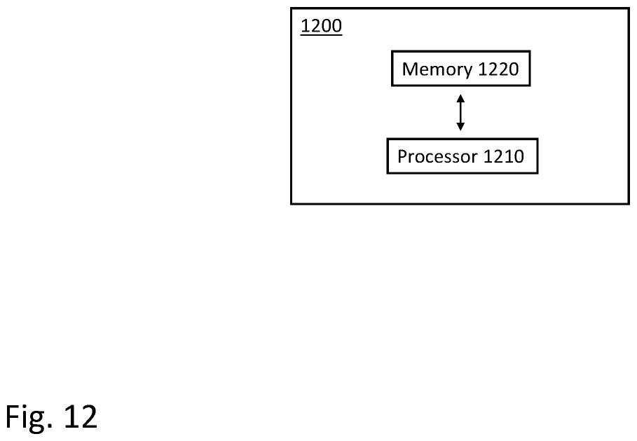

FIG. 12 shows an example embodiment of an apparatus 1200. The apparatus 1200 may comprise at least one processor 1210 and at least one memory 1220 comprising computer program code. At the system level, the at least one memory and the computer program code may be configured, with the at least one processor, to cause the steps of the example flowchart 1000 to be performed. At the device level, the at least one memory and the computer program code may be configured, with the at least one processor, to cause the steps of the example flowchart 1100 to be performed.

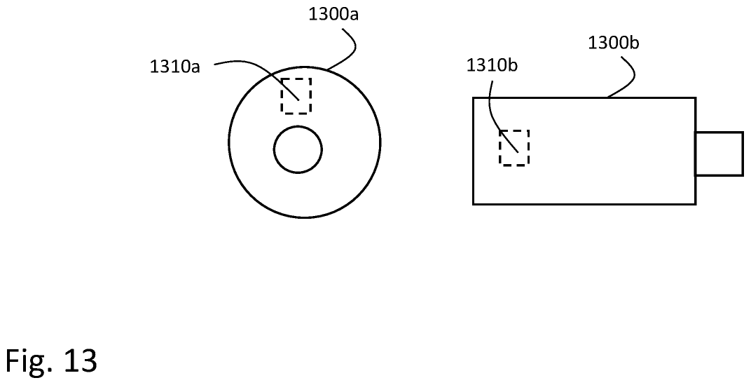

FIG. 13 shows an example embodiment of computer readable media, such as non-transitory computer readable media 1300a (e.g., a computer disc (CD) or a digital versatile disc (DVD)) and 1300b (e.g., a universal serial bus (USB) memory stick), which may be configured to store instructions and/or parameters 1310a, 1310b that, when executed by a processor, may allow the processor to perform one or more of the steps of any of the methods of any of the example embodiments.

In summary, the proposed solution may allow to avoid any inter-cell beam collision using an adequate ML-assisted beams coordinated scheduling which may selectively limit the use of co-scheduled beams on identical time and frequency resources thanks to application, by a respective scheduler at each cell, of an established (or setup) beam scheduling policy.

It should be noted that the cross-beam inter-cell interference profiles may be used not only for the proposed ML-assisted beams coordinated scheduling to mitigate inter-cell interference, but also for optimization of the beam pattern.

It should be appreciated that, while the above has described some example embodiments, there are several variations and modifications which may be made to the disclosed solution without departing from the scope of the present application.

The embodiments may thus vary within the scope of the attached claims. In general, some embodiments may be implemented in hardware or special purpose circuits, software, logic or any combination thereof. For example, some aspects may be implemented in hardware, while other aspects may be implemented in firmware or software which may be executed by a controller, microprocessor or other computing device, although embodiments are not limited thereto. While various embodiments may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments may be implemented by computer software stored in a memory and executable by at least one data processor of the involved entities or by hardware, or by a combination of software and hardware. Further in this regard it should be noted that any of the above procedures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi core processor architecture, as non-limiting examples.

The foregoing description has provided by way of exemplary and non-limiting examples a full and informative description of some embodiments. However, various modifications and adaptations may become apparent to those skilled in the relevant arts in view of the foregoing description, when read in conjunction with the accompanying drawings and the appended claims. However, all such and similar modifications of the teachings will still fall within the scope as defined in the appended claims.

1. A method, comprising:
receiving, at a data collection entity, from a cell, a time series of a respective set of data where the set of data comprises at least: one or more per-cell performance measurement data, one or more per-cell serving beams of a scheduled user equipment device, and a time and frequency allocation of the scheduled user equipment device to be served with the corresponding one or more per-cell serving beams;
generating, with a centralized self-organizing network entity, from the sets of data received from the data collection entity, a set of cross-beam inter-cell interference profiles;
establishing, with the centralized self-organizing network entity, from at least the set of cross-beam inter-cell interference profiles, a beam scheduling policy;
receiving, at the cell, from the centralized self-organizing network entity, the beam scheduling policy; and
applying, with a respective scheduler at the cell, the beam scheduling policy to the one or more per-cell serving beams.

2. The method of claim 1, wherein the set of cross-beam inter-cell interference profiles comprises at least a respective interference probability for the serving beam pair of co-scheduled beams and a respective compliancy level for the set of co-scheduled beams, the co-scheduled beams comprising at least two serving beams which are from a respective cell and which are scheduled on the same time and frequency resources.

3. The method of claim 2, wherein the step of generating a set of cross-beam intercell interference profiles comprises at least:
labelling the set of co-scheduled beams as normal or abnormal depending on the one or more per-cell performance measurement data;
training a machine learning model using the labelled set of co-scheduled beams and the one or more per-cell performance measurement data, as to obtain a trained machine learning model;
using the trained machine learning model on the one or more per-cell performance measurement data per realization of co-scheduled beams to classify the set of co-scheduled beams as normal or abnormal depending on their respective compliancy level; and
computing the respective interference probability for the serving beam pair of co-scheduled beams.

4. The method of claim 3, wherein the compliancy level is correlated to a crossbeam inter-cell interference level and to the one or more per-cell performance measurement data, the set of co-scheduled beams being classified as abnormal when the respective compliancy level is correlated to a high cross-beam inter-cell interference level and as normal when the respective compliancy level is correlated to a low cross-beam inter-cell interference level.

5. The method of claim 3, wherein the step of labelling the set of co-scheduled beams as normal or abnormal depending on the one or more per-cell performance measurement data is based at least on at least one of:
a first anomaly detection with:
detecting an outlier based on the one or more per-cell performance measurement data;
determining whether or not the detected outlier is associated with a performance degradation;
labelling the set of co-scheduled beams corresponding to the detected outlier as abnormal when the detected outlier is associated with the performance degradation;
labelling the set of co-scheduled beams corresponding to the detected outlier as normal when the detected outlier is not associated with the performance degradation; and
labelling the other set of co-scheduled beams corresponding to no detected outlier as normal; or
a second anomaly detection with:
forming a data cluster from the one or more per-cell performance measurement data;
determining whether or not the data cluster is associated with a performance degradation;
labelling the set of co-scheduled beams corresponding to the data of the data cluster as abnormal when the data cluster is associated with the performance degradation; and
labelling the set of co-scheduled beams corresponding to the data of the data cluster as normal when the data cluster is not associated with the performance degradation.

6. The method of any of claim 2, wherein the step of establishing a beam scheduling policy comprises:
building a pattern of beam penalties which are to be applied per cell to ach of the one or more per-cell serving beams in order to selectively limit a use of one or more co-scheduled beams from respective cells on identical time and frequency resources.

7. The method of claim 6, wherein the pattern comprises one of a space time pattern, a space frequency pattern, and a space time and frequency pattern.

8. The method of claim 6, wherein the step of building a pattern of beam penalties comprises, when an interference probability is determined high for a serving beam pair of co-scheduled beams including a first serving beam from a cell and a second serving beam from another cell:
assigning a high level of beam penalty to the first serving beam and a low level of beam penalty to the second serving beam at a given slot, so as to limit a use of the first serving beam with respect to the second serving beam during the given slot; and
assigning a low level of beam penalty to the first serving beam and a high level of beam penalty to the second serving beam at another slot subsequent to the given slot, so as to limit a use of the second serving beam with respect to the first serving beam during said another slot, wherein the slot comprises at least one of a time slot and a frequency slot, or
assigning a low level of beam penalty to the first serving beam and a high level of beam penalty to the second serving beam at a given slot, so as to limit a use of the second serving beam with respect to the first serving beam during the given slot; and
assigning a high level of beam penalty to the first serving beam and a low level of beam penalty to the second serving beam at another slot subsequent to the given slot, so as to limit a use of the first serving beam with respect to the second serving beam during said another slot, wherein the slot comprises at least one of a time slot and a frequency slot.

9. The method of claim 6, wherein the step of applying the beam scheduling policy to the one or more per-cell serving beams comprises:
determining, with the respective scheduler at the cell, which user equipment device and corresponding serving beam to schedule based on at least the pattern of beam penalties.

10. A method, comprising:
receiving, from a data collection entity, a time series of a respective set of data from the cell, where the set of data comprises at least: one or more per-cell performance measurement data, one or more per-cell serving beams of a scheduled user equipment device, and a time and frequency allocation of the scheduled user equipment device to be served with the corresponding one or more per-cell serving beams;
generating, from the sets of data, a set of cross-beam inter-cell interference profiles;
establishing, from at least the set of cross-beam inter-cell interference profiles, a beam scheduling policy; and
transmitting, to a respective scheduler in the cell, the beam scheduling policy for application to the one or more per-cell serving beams.

11. An apparatus, comprising:
at least one processor; and
at least one non-transitory memory storing instructions that, when executed with the at least one processor, cause the apparatus to perform:
receiving, at a data collection entity, from a cell, a time series of a respective set of data where a set of data comprises at least: one or more per-cell performance measurement data, one or more per-cell serving beams of a scheduled user equipment device, and a time and frequency allocation of the scheduled user equipment device to be served with the corresponding one or more per-cell serving beams;
generating, with a centralized self-organizing network entity, from the sets of data received from the data collection entity, a set of cross-beam inter-cell interference profiles;
establishing, with the centralized self-organizing network entity, from at least the set of cross-beam inter-cell interference profiles, a beam scheduling policy;
receiving, at the cell, from the centralized self-organizing network entity, the beam scheduling policy; and
applying, with a respective scheduler at the cell, the beam scheduling policy to ach of the one or more per-cell serving beams.

12. (canceled)

13. A centralized self-organizing network entity comprising:
at least one processor; and
at least one non-transitory memory storing instructions that, when executed with the at least one processor, cause the centralized self-organizing network to perform:
receiving, from a data collection entity, a time series of a respective set of data from a cell, where the set of data comprises at least:
one or more per-cell performance measurement data, one or more per-cell serving beams of a scheduled user equipment device, and a time and frequency allocation of the scheduled user equipment device to be served with the corresponding one or more per-cell serving beams;
generating, from the sets of data, a set of cross-beam inter-cell interference profiles;
establishing, from at least the set of cross-beam inter-cell interference profiles, a beam scheduling policy; and
transmitting, to a respective scheduler in the cell, the beam scheduling policy for application to the one or more per-cell serving beams.

14. (canceled)

15. A non-transitory program storage device readable with an apparatus tangibly embodying a program of instructions executable with the apparatus for performing operations, the operations comprising the method of claim 1.

16. A non-transitory program storage device readable with an apparatus tangibly embodying a program of instructions executable with the apparatus for performing operations, the operations comprising the method of claim 10.
